(19) United States
(12) Patent Application Publication
(10) Pub. No.: US 2025/0173612 A1
(43) Pub. Date: May 29, 2025

(54) MACHINE LEARNING MODEL MANAGEMENT AND ASSISTANCE INFORMATION

(71) Applicant: QUALCOMM Incorporated, San Diego, CA (US)

(72) Inventors: Chenxi HAO, Beijing (CN); Taesang YOO, San Diego, CA (US); Jay Kumar SUNDARARAJAN, San Diego, CA (US); Xipeng ZHU, San Diego, CA (US); Rajeev KUMAR, San Diego, CA (US); Shankar KRISHNAN, Poway, CA (US)

(21) Appl. No.: 18/841,980

(22) PCT Filed: Apr. 29, 2022
(86) PCT No.: PCT/CN2022/090610

§ 371 Date: Aug. 27, 2024

(51) Int. Cl. G06N 20/00

(52) U.S. Cl. CPC G06N 20/00

(57) ABSTRACT

Certain aspects of the present disclosure provide method of wireless communications by a user equipment (UE), generally including obtaining, from a network entity, a performance report for a machine learning (ML) model running on at least one of the UE or a network entity and participating in a change to the ML model based on the performance report.

### BACKGROUND

### Field of the Disclosure

Aspects of the present disclosure relate to wireless communications, and more particularly, to techniques for enhancing machine learning (ML) based models used in wireless communications systems.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications (e.g., by a user equipment (UE)). The method includes obtaining, from a network entity, a performance report for a machine learning (ML) model running on at least one of the UE or a network entity; and participating in a change to the ML model based on the performance report.

Another aspect provides a method of wireless communications by a UE. The method includes include generating a performance report for a ML model running on at least one of the UE or a network entity; and participating in a change to the ML model based on the performance report.

Another aspect provides a method of wireless communications by a network entity. The method includes transmitting a performance report for a ML model running on at least one of a UE or the network entity; and participating in a change to the ML model based on the performance report.

Another aspect provides a method of wireless communications by a network entity. The method includes receiving a performance report for a ML model running on at least one of a UE or the network entity; and participating in a change to the ML model based on the performance report.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates example beam refinement procedures, in accordance with certain aspects of the present disclosure

FIG. 6 is a diagram illustrating example operations where beam management may be performed.

FIG. 7 illustrates a general functional framework applied for AI-enabled RAN intelligence.

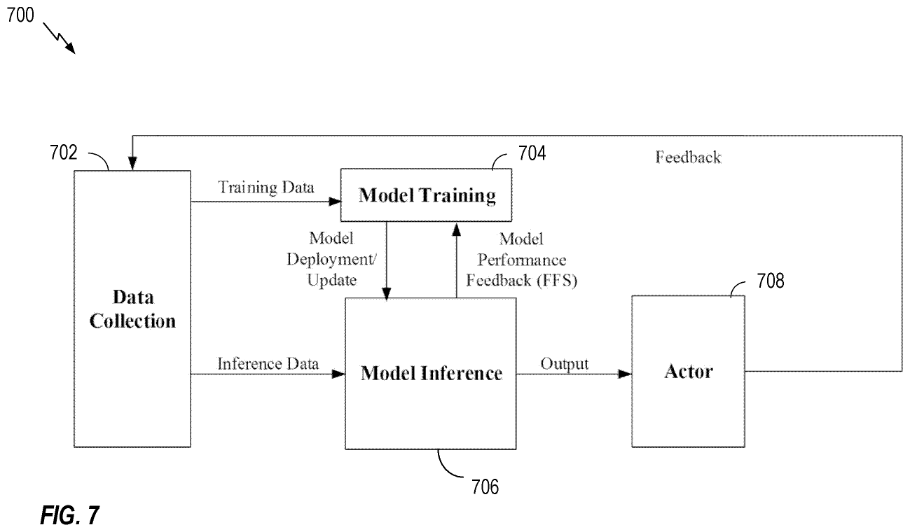

FIG. 8 depicts an example of monitoring a machine learning model performance over time.

FIG. 9 depicts an example of an ML-based CSI feedback mechanism.

FIG. 10 depicts an example of encoder input and decoder output for the ML-based CSI feedback mechanism of FIG. 9.

FIG. 11 depicts an example of network-side ML model retraining or switching decision, in accordance with aspects of the present disclosure.

FIG. 12 depicts an example of UE-side ML model retraining or switching decision, in accordance with aspects of the present disclosure.

FIG. 13 depicts an example of UE-side ML model performance monitoring, in accordance with aspects of the present disclosure.

FIG. 14 depicts a method for wireless communications.

FIG. 15 depicts a method for wireless communications.

FIG. 16 depicts a method for wireless communications.

FIG. 17 depicts a method for wireless communications.

FIG. 18 depicts aspects of an example communications device.

### DETAILED DESCRIPTION

Aspects of the present disclosure provide apparatuses, methods, processing systems, and computer-readable mediums for managing models for channel state estimation and feedback.

Understanding the channel state between devices communicating in a wireless communications system is an important aspect of improving the performance of wireless communications. Conventionally, many techniques have been employed for measuring the channel state and reporting feedback so that performance can be improved. However, such conventional techniques are often relatively slow, power hungry, and static in approach.

Machine learning represents an opportunity to improve upon many conventional techniques for measuring channel state and reporting feedback. For example, machine learning models may reduce the number of resource elements needed for estimating a channel state, and improve the estimates of values used in reporting the channel state. However, because the wireless environment tends to be extremely dynamic, it is important to be able to monitor the performance of the machine learning models implementing critical channel state measuring and feedback procedures and to take remedial action if, for example, a model starts to underperform. Such remedial action may include, for example, falling back to a baseline model (e.g., a non-machine-learning model) to perform various aspects until the machine learning model can be reconfigured to maintain optimal performance.

Aspects described herein relate generally to methods for monitoring performance and detecting failures related to machine learning models used for channel state measuring and feedback procedures. In various aspects, a network may configure and/or a user equipment may implement various modes for monitoring model performance. In some aspects, model performance is monitored by determining output variance events and for reporting such variance events to a network and/or using such variance events to determine when a model has become unreliable or “failed.” In some aspects, a model variance event may be an out-of-distribution (OOD) event, which generally refers to a machine learning model generating an uncertain output based on an input that differs from its training data.

By actively monitoring the performance of and detecting failures with respect to machine learning models, with or without the assistance of the network, aspects described herein enable the benefits of machine learning models, such as faster, more power efficient, and more accurate operation, while mitigating simultaneously against the possibility of machine learning model performance degradation over time. Such degradation may be caused, for example, by a machine learning model being exposed to new environments and new conditions that were not initially accounted for during training of the machine learning model. In the context of various examples described herein, that may include a user equipment performing channel estimation and predicting channel state information feedback using machine learning models in a radio environment different from the environments considered during training of the models. Detecting such degradations allow for reconfiguring (e.g., retraining) the machine learning models to maintain state of the art performance, and for falling back to baseline models in the meantime.

Thus, aspects described herein, which enable robust use of machine learning models for channel state measuring and feedback procedures, enhance wireless communications performance generally, and more specifically through reduced power use, increased battery life, improved spectral efficiency, reduced latency, and decreased network overhead, to name a few technical improvements.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

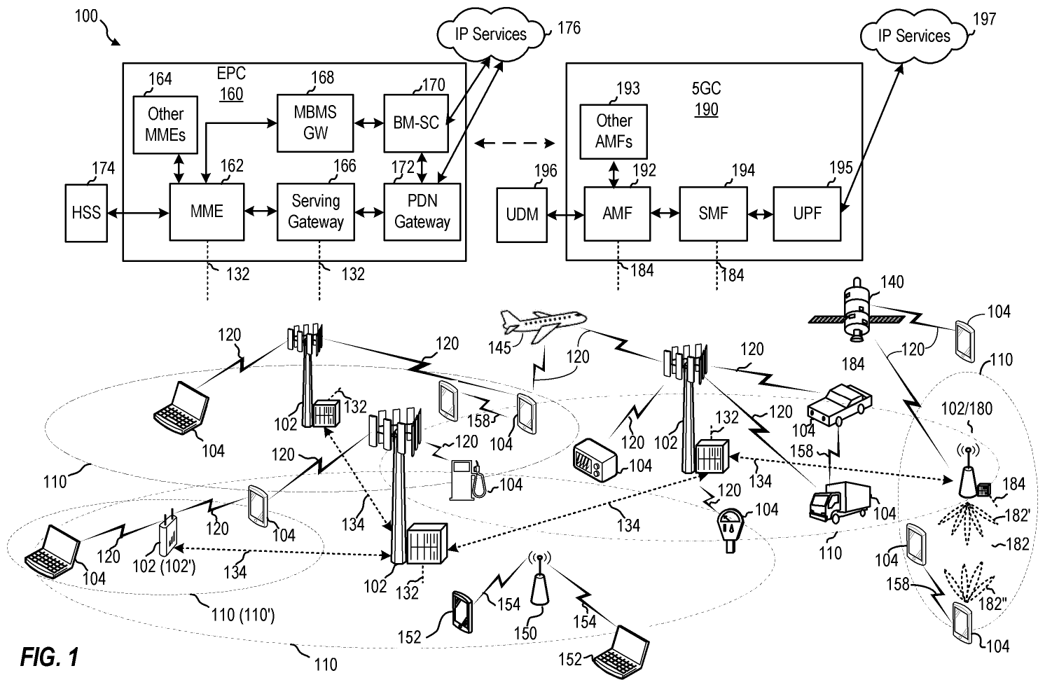

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

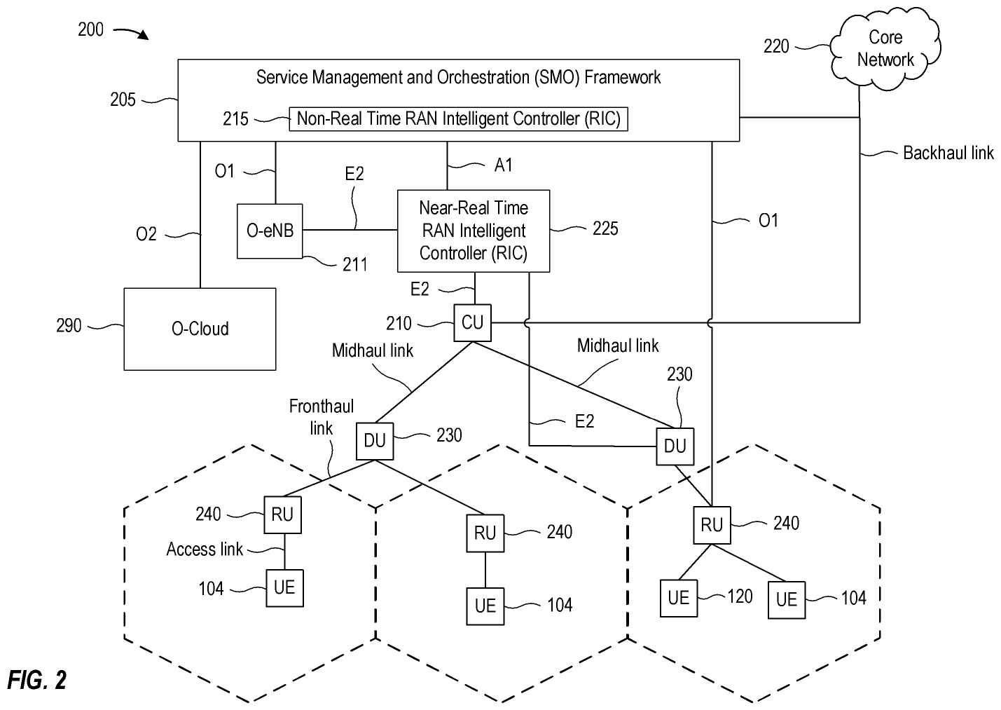

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mmWave”). A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

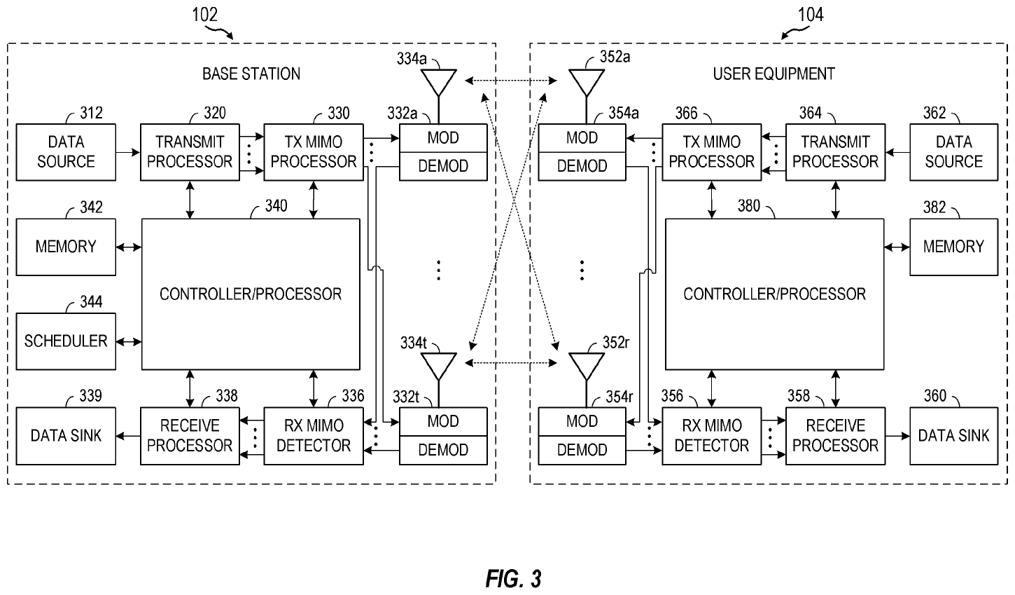

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

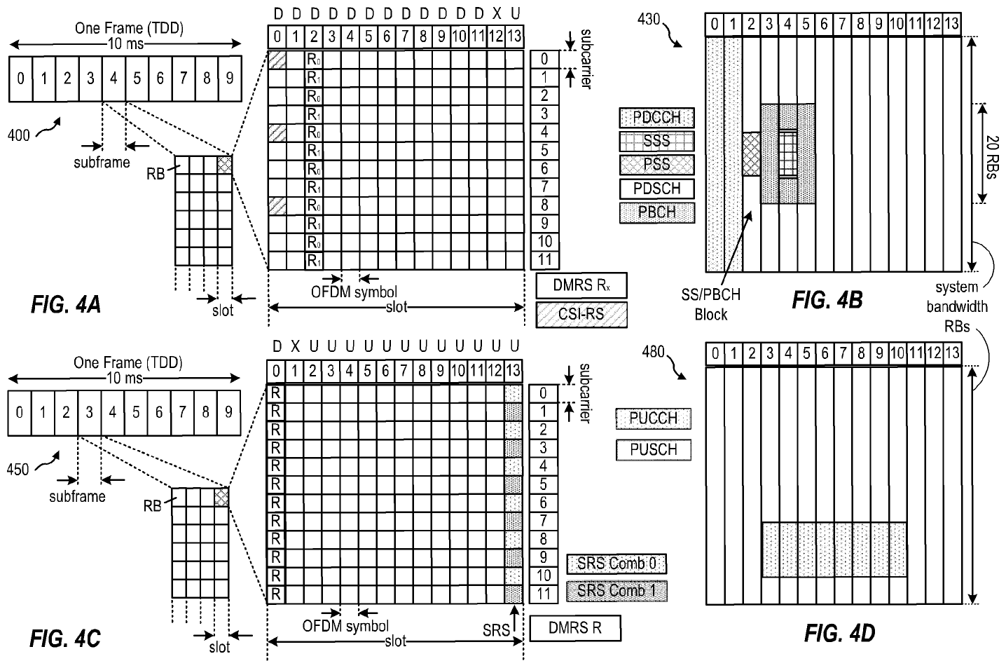

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Beam Refinement Procedures

In mmWave systems, beam forming may be needed to overcome high path-losses. As described herein, beamforming may refer to establishing a link between a BS and UE, wherein both of the devices form a beam corresponding to each other. Both the BS and the UE find at least one adequate beam to form a communication link. BS-beam and UE-beam form what is known as a beam pair link (BPL). As an example, on the DL, a BS may use a transmit beam and a UE may use a receive beam corresponding to the transmit beam to receive the transmission. The combination of a transmit beam and corresponding receive beam may be a BPL.

As a part of beam management, beams which are used by BS and UE have to be refined from time to time because of changing channel conditions, for example, due to movement of the UE or other objects. Additionally, the performance of a BPL may be subject to fading due to Doppler spread. Because of changing channel conditions over time, the BPL should be periodically updated or refined. Accordingly, it may be beneficial if the BS and the UE monitor beams and new BPLs.

At least one BPL has to be established for network access. As described above, new BPLs may need to be discovered later for different purposes. The network may decide to use different BPLs for different channels, or for communicating with different BSs (TRPs) or as fallback BPLs in case an existing BPL fails.

The UE typically monitors the quality of a BPL and the network may refine a BPL from time to time.

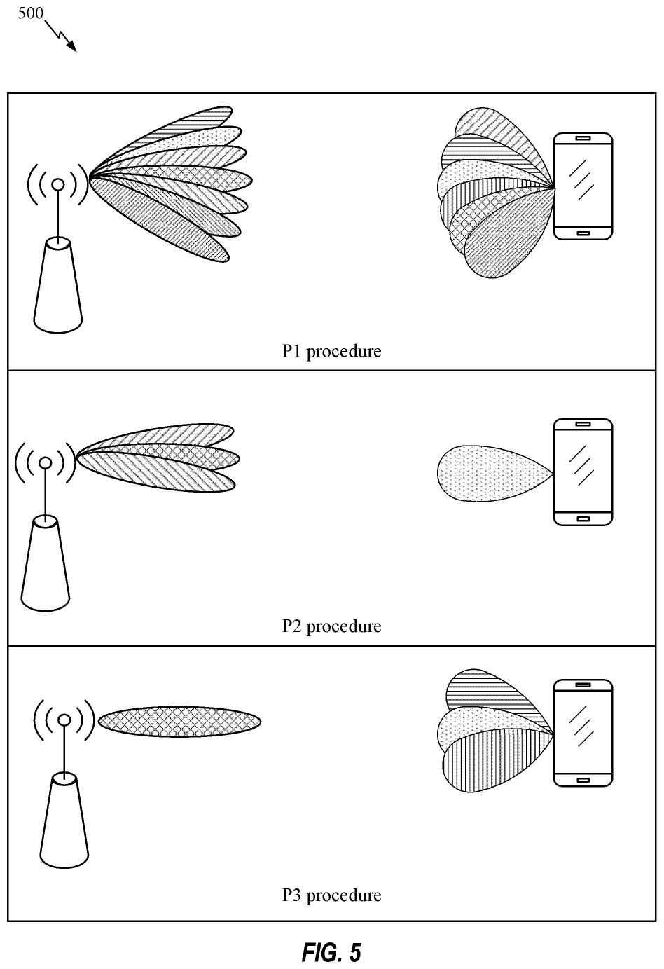

FIG. 5 illustrates example 500 for BPL discovery and refinement. In 5G-NR, the P1, P2, and P3 procedures are used for BPL discovery and refinement. The network uses a P1 procedure to enable the discovery of new BPLs. In the P1 procedure, as illustrated in FIG. 5, the BS transmits different symbols of a reference signal, each beam formed in a different spatial direction such that several (most, all) relevant places of the cell are reached. Stated otherwise, the BS transmits beams using different transmit beams over time in different directions.

For successful reception of at least a symbol of this “P1-signal”, the UE has to find an appropriate receive beam. It searches using available receive beams and applying a different UE-beam during each occurrence of the periodic P1-signal.

Once the UE has succeeded in receiving a symbol of the P1-signal it has discovered a BPL. The UE may not want to wait until it has found the best UE receive beam, since this may delay further actions. The UE may measure the reference signal receive power (RSRP) and report the symbol index together with the RSRP to the BS. Such a report will typically contain the findings of one or more BPLs.

In an example, the UE may determine a received signal having a high RSRP. The UE may not know which beam the BS used to transmit; however, the UE may report to the BS the time at which it observed the signal having a high RSRP. The BS may receive this report and may determine which BS beam the BS used at the given time.

The BS may then offer P2 and P3 procedures to refine an individual BPL. The P2 procedure refines the BS-beam of a BPL. The BS may transmit a few symbols of a reference signal with different BS-beams that are spatially close to the BS-beam of the BPL (the BS performs a sweep using neighboring beams around the selected beam). In P2, the UE keeps its beam constant. Thus, while the UE uses the same beam as in the BPL (as illustrated in P2 procedure in FIG. 5). The BS-beams used for P2 may be different from those for P1 in that they may be spaced closer together or they may be more focused. The UE may measure the RSRP for the various BS-beams and indicate the best one to the BS.

The P3 procedure refines the UE-beam of a BPL (see P3 procedure in FIG. 5). While the BS-beam stays constant, the UE scans using different receive beams (the UE performs a sweep using neighboring beams). The UE may measure the RSRP of each beam and identify the best UE-beam. Afterwards, the UE may use the best UE-beam for the BPL and report the RSRP to the BS.

Overtime, the BS and UE establish several BPLs. When the BS transmits a certain channel or signal, it lets the UE know which BPL will be involved, such that the UE may tune in the direction of the correct UE receive beam before the signal starts. In this manner, every sample of that signal or channel may be received by the UE using the correct receive beam. In an example, the BS may indicate for a scheduled signal (SRS, CSI-RS) or channel (PDSCH, PDCCH, PUSCH, PUCCH) which BPL is involved. In NR this information is called QCL indication.

Two antenna ports are QCL if properties of the channel over which a symbol on one antenna port is conveyed may be inferred from the channel over which a symbol on the other antenna port is conveyed. QCL supports, at least, beam management functionality, frequency/timing offset estimation functionality, and RRM management functionality.

The BS may use a BPL which the UE has received in the past. The transmit beam for the signal to be transmitted and the previously-received signal both point in a same direction or are QCL. The QCL indication may be needed by the UE (in advance of signal to be received) such that the UE may use a correct receive beam for each signal or channel. Some QCL indications may be needed from time to time when the BPL for a signal or channel changes and some QCL indications are needed for each scheduled instance. The QCL indication may be transmitted in the downlink control information (DCI) which may be part of the PDCCH channel. Because DCI is needed to control the information, it may be desirable that the number of bits needed to indicate the QCL is not too big. The QCL may be transmitted in a medium access control-control element (MAC-CE) or radio resource control (RRC) message.

According to one example, whenever the UE reports a BS beam that it has received with sufficient RSRP, and the BS decides to use this BPL in the future, the BS assigns it a BPL tag. Accordingly, two BPLs having different BS beams may be associated with different BPL tags. BPLs that are based on the same BS beams may be associated with the same BPL tag. Thus, according to this example, the tag is a function of the BS beam of the BPL.

As noted above, wireless systems, such as millimeter wave (mmW) systems, bring gigabit speeds to cellular networks, due to availability of large amounts of bandwidth. However, the unique challenges of heavy path-loss faced by such wireless systems necessitate new techniques such as hybrid beamforming (analog and digital), which are not present in 3G and 4G systems. Hybrid beamforming may enhance link budget/signal to noise ratio (SNR) that may be exploited during the RACH.

In such systems, the node B (NB) and the user equipment (UE) may communicate over active beam-formed transmission beams. Active beams may be considered paired transmission (Tx) and reception (Rx) beams between the NB and UE that carry data and control channels such as PDSCH, PDCCH, PUSCH, and PUCCH. As noted above, a transmit beam used by a NB and corresponding receive beam used by a UE for downlink transmissions may be referred to as a beam pair link (BPL). Similarly, a transmit beam used by a UE and corresponding receive beam used by a NB for uplink transmissions may also be referred to as a BPL.

In such systems, the node B (NB) and the user equipment (UE) may communicate over active beam-formed transmission beams. Active beams may be considered paired transmission (Tx) and reception (Rx) beams between the NB and UE that carry data and control channels such as PDSCH, PDCCH, PUSCH, and PUCCH. As noted above, a transmit beam used by a NB and corresponding receive beam used by a UE for downlink transmissions may be referred to as a beam pair link (BPL). Similarly, a transmit beam used by a UE and corresponding receive beam used by a NB for uplink transmissions may also be referred to as a BPL.

Since the direction of a reference signal is unknown to the UE, the UE may need to evaluate several beams to obtain the best Rx beam for a given NB Tx beam. However, if the UE has to “sweep” through all of its Rx beams to perform the measurements (e.g., to determine the best Rx beam for a given NB Tx beam), the UE may incur significant delay in measurement and battery life impact. Moreover, having to sweep through all Rx beams is highly resource inefficient. Thus, aspects of the present disclosure provide techniques to assist a UE when performing measurements of serving and neighbor cells when using Rx beamforming.

### Example Beam Management

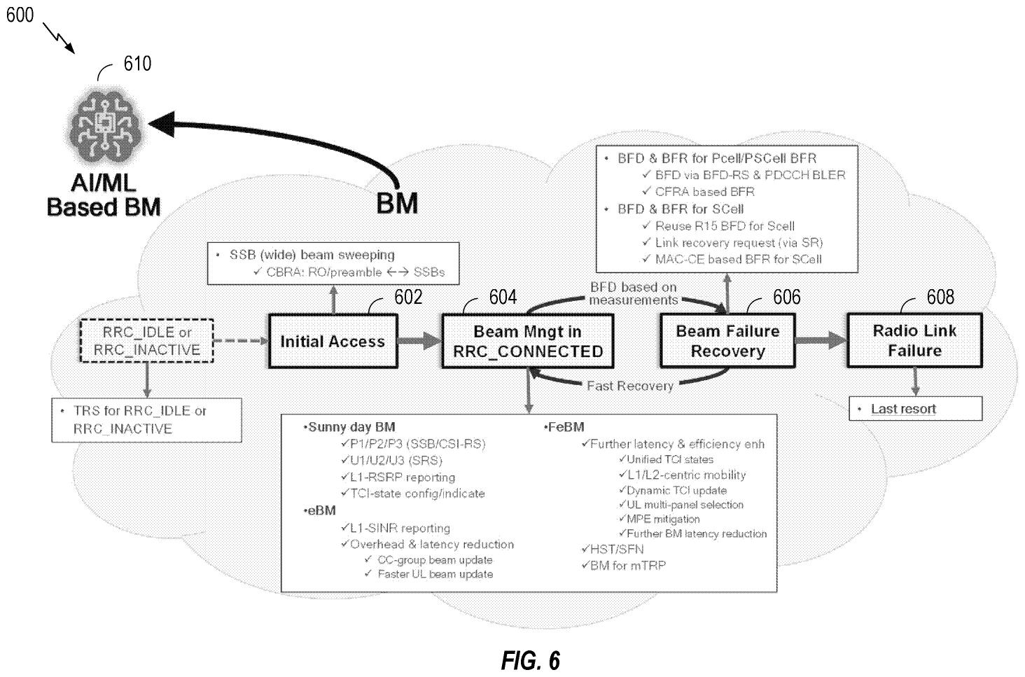

In wireless communications, various procedures may be performed for beam management. FIG. 6 is a diagram illustrating example operations where beam management may be performed. In initial access 602, the network may sweep through several beams, for example, via synchronization signal blocks (SSBs), as further described herein with respect to FIG. 4B. The network may configure the UE with random access channel (RACH) resources associated with the beamformed SSBs to facilitate the initial access via the RACH resources. In certain aspects, an SSB may have a wider beam shape compared to other reference signals, such as a channel state information reference signal (CSI-RS). A UE may use SSB detection to identify a RACH occasion (RO) for sending a RACH preamble (e.g., as part of a contention CBRA procedure).

In connected mode 604, the network and UE may perform hierarchical beam refinement including beam selection (e.g., a process referred to as P1), beam refinement for the transmitter (e.g., a process referred to as P2), and beam refinement for the receiver (e.g., a process referred to as P3). In beam selection (P1), the network may sweep through beams, and the UE may report the beam with the best channel properties, for example. In beam refinement for the transmitter (P2), the network may sweep through narrower beams, and the UE may report the beam with the best channel properties among the narrow beams. In beam refinement for the receiver (P3), the network may transmit using the same beam repeatedly, and the UE may refine spatial reception parameters (e.g., a spatial filter) for receiving signals from the network via the beam. In certain aspects, the network and UE may perform complementary procedures (e.g., U1, U2, and U3) for uplink beam management.

In certain cases where a beam failure occurs (e.g., due to beam misalignment and/or blockage), the UE may perform a beam failure recovery (BFR) procedure 606, which may allow a UE to return to connected mode 604 without performing a radio link failure procedure 608. For example, the UE may be configured with candidate beams for beam failure recovery. In response to detecting a beam failure, the UE may request the network to perform beam failure recovery via one of the candidate beams (e.g., one of the candidate beams with a reference signal received power (RSRP) above a certain threshold). In certain cases where radio link failure (RLF) occurs, the UE may perform an RLF procedure 608 to recover from the radio link failure, such as a RACH procedure.

### AI/ML Functional Framework for RAN Intelligence

The AI/ML functional framework includes a data collection function 702, a model training function 704, a model inference function 706, and an actor function 708, which interoperate to provide a platform for collaboratively applying AI/ML to various procedures in RAN.

The data collection function 702 generally provides input data to the model training function 704 and the model inference function 706. AI/ML algorithm specific data preparation (e.g., data pre-processing and cleaning, formatting, and transformation) may not be carried out in the data collection function 702.

Examples of input data to the data collection function 702 (or other functions) may include measurements from UEs or different network entities, feedback from the actor function, and output from an AI/ML model. In some cases, analysis of data needed at the model training function 704 and the model inference function 706 may be performed at the data collection function 702. As illustrated, the data collection function 702 may deliver training data to the model training function 704 and inference data to the model inference function 706.

The model training function 704 may perform AI/ML model training, validation, and testing, which may generate model performance metrics as part of the model testing procedure. The model training function 704 may also be responsible for data preparation (e.g., data pre-processing and cleaning, formatting, and transformation) based on the training data delivered by the data collection function 702, if required.

The model training function 704 may provide model deployment/update data to the Model interface function 706. The model deployment/update data may be used to initially deploy a trained, validated, and tested AI/ML model to the model inference function 706 or to deliver an updated model to the model inference function 706.

As illustrated, the model inference function 706 may provide AI/ML model inference output (e.g., predictions or decisions) to the actor function 708 and may also provide model performance feedback to the model training function 704, at times. The model inference function 706 may also be responsible for data preparation (e.g., data pre-processing and cleaning, formatting, and transformation) based on inference data delivered by the data collection function 702, at times.

The inference output of the AI/ML model may be produced by the model inference function 706. Specific details of this output may be specific in terms of use cases. The model performance feedback may be used for monitoring the performance of the AI/ML model, at times. In some cases, the model performance feedback may be delivered to the model training function 704, for example, if certain information derived from the model inference function is suitable for improvement of the AI/ML model trained in the model training function 704.

The model inference function 706 may signal the outputs of the model to nodes that have requested them (e.g., via subscription), or nodes that take actions based on the output from the model inference function. An AI/ML model used in a model inference function 706 may need to be initially trained, validated and tested by a model training function before deployment. The model training function 704 and model inference function 706 may be able to request specific information to be used to train or execute the AI/ML algorithm and to avoid reception of unnecessary information. The nature of such information may depend on the use case and on the AI/ML algorithm.

The actor function 708 may receive the output from the model inference function 706, which may trigger or perform corresponding actions. The actor function 708 may trigger actions directed to other entities or to itself. The feedback generated by the actor function 708 may provide information used to derive training data, inference data or to monitor the performance of the AI/ML Model. As noted above, input data for a data collection function 702 may include this feedback from the actor function 708. The feedback from the actor function 708 or other network entities (via Data Collection function) may also be used at the model inference function 706.

The AI/ML functional framework 700 may be deployed in various RAN intelligence-based use cases. Such use cases may include CSI feedback enhancement, enhanced beam management (BM), positioning and location (Pos-Loc) accuracy enhancement, and various other use cases.

In certain aspects, a UE or a BS may perform ML-based beam prediction using continuous measured or reported L1-RSRP in time domain. In some cases, a pre-trained deep neural network (DNN) model may be used for such ML-based predictive beam management.

Traditionally, beam qualities and failures are identified through measurement reports carried by relevant downlink (DL) and uplink (UL) reference signals (e.g., SSB, CSI-RS, RSRP), which increase beam selection latency and beam management overhead, while at the same beam selection accuracy may be limited due to restrictions on power and overhead that may cause poor system performance.

Instead, the AI/ML based predictive beam management may reduce the amount of reference signal transmissions used to predict non-measured beam qualities and future possibility of beam blockage/failure. In predictive beam management, beam prediction may be a highly non-linear problem, which may be efficiently solved by the pre-trained DNN model that may predict future beam qualities, for example, based on a UE moving speed and trajectory that is difficult to be modeled through conventional statistical processing methods.

### Aspects Related to ML Model Management and Assistance Information

Conventionally, several techniques have been used to help determine the channel state between wireless communications devices so that those devices can optimize their wireless communications configurations (e.g., choosing the best beam for transmitting and receiving data). For example, a channel state information reference signal (CSI-RS) may be transmitted by one device and measured by another device in order to estimate channel state and to provide channel state information (CSI) feedback that is useful for optimizing wireless communications between the two devices.

However, owing to the growing complexity and capability of wireless communication devices, such as those capable of transmitting and receiving over multiple input and output antenna ports (e.g., implementing multiple-input multiple-output (MIMO) techniques), conventional techniques may require significant processing power and time, which reduces the performance of both the devices and the overall wireless communications network. These technical problems are exacerbated by the typical use cases and environments for wireless communications, which are often dynamic. In other words, because channel state is frequently changing, channel estimation and feedback procedures are often performed frequently, leading to high power use and significant network overhead (e.g., in terms of time and frequency resources dedicated to channel estimation) for the wireless communication system. One method of mitigating such issues is to implement machine learning models that may more accurately, and more efficiently, perform various functions related to channel state estimation and feedback.

For example, conventional wireless communication systems may multiplex Nₜ ports on Nₜ resource elements of each resource block using, for example, time division multiplexing (TDM), code division multiplexing (CDM), and/or frequency division multiplexing (FDM). Such systems may generally implement a resource block density between 0.5 and 1, such that the resource elements are transmitted in every other or every single resource block. By contrast, a machine learning model deployed by a transmitting device (e.g., a base station) may be trained to perform multiplexing of Nₜ ports on L resource elements of each resource block, where L<Nₜ, which thus reduces the number of resource elements needed for channel estimation-leaving more resource elements available for data transmission. In addition to reducing the number of resource elements needed for channel estimation, which reduces power and enhances resource utilization, such models may operate with reduced resource block density (e.g., below 0.5) and non-uniform resource block patterns may also be implemented, which further improve upon the aforementioned benefits. At a receiving device (e.g., a user equipment) side, a machine learning-based channel estimator may be trained to recover the full channel, e.g., Nₜ ports on all resource blocks while receiving the reduced number of resource, L. In various aspects, CSI-RS multiplexing models at transmitter side and receiver side may be trained jointly or sequentially.

As another example, a conventional CSI reporting configuration may rely on a precoding matrix indicator (PMI) searching algorithm as well as a PMI codebook for determining and reporting the best PMI codewords (e.g., CSI feedback) to a network. However, a machine learning-based model, such as an encoder and decoder, may be trained to generate CSI feedback directly, which obviates the need for the PMI searching algorithm (replaced by the encoder) and the PMI codebook (replaced by the decoder). In aspects described herein, a CSI encoder at the user equipment side may be trained to compress the channel estimate to a few bits that are then reported to a network entity (e.g., a base station), while the CSI decoder at the network entity side is trained to recover the channel or the precoding matrix using the reported bits.

Thus, generally speaking, machine learning models may be trained to perform many functions related to channel estimation and feedback, and such models may generally be more accurate, faster, more power efficient, and more capable of maintaining performance in very dynamic radio environments. However, it is nevertheless important to monitor the performance of such machine learning models to ensure robust performance over time.

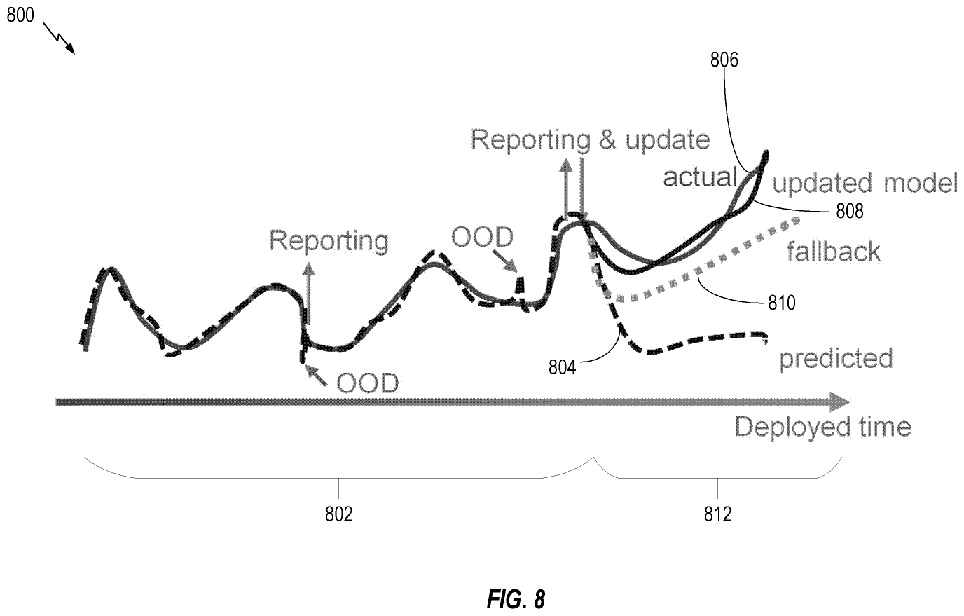

FIG. 8 depicts an example 800 of monitoring a machine learning model performance over time.

As depicted, during time interval 802, the model output 804 closely tracks the actual values 806 (e.g., of a channel estimation). The model may be deployed by a user equipment, such as user equipment 104 described with respect to FIGS. 1 and 3. During interval 802, there are two reporting events in which the device deploying the model reports the performance of the model, including the two out-of-distribution (OOD) events. Notably, the OOD events depict instances in which model output deviates significantly (e.g., based on a threshold) from the actual values 806. In these instances, the trained model may be processing input data that is significantly different than the training data used to train the model, and thus the model output becomes unreliable. Based on these OOD events, a network entity, such as the base station 102 described with respect to FIGS. 1-3, may determine to send a model update.

The second time interval 804 demonstrates various possible outcomes. Without a model update, the original model output 804 deviates significantly from the actual values 806. By contrast, the updated model output 808 again closely tracks the actual values 806. Further, a fallback method, such as a conventional, non-machine learning-based method, is depicted to demonstrate that such methods may be better than a poorly performing machine learning model, but worse than a well performing machine learning model.

There are various options for what type of information to feedback as channel state feedback (CSF) and the decision of what to feedback may depend on a particular implementation (e.g., whether AI/ML-based or not). The type of feedback may range (in a continuum from relatively sparse information, such as rank indicator (RI), PMI, and channel quality indicator (CQI), to detailed, full channel, information.

In current systems, for CSI feedback, a CSI report configuration typically includes a codebook. The codebook is used as a precoding matrix indicator (PMI) dictionary, from which the UE may select and report the best PMI codewords, using a sequence of bits to report the PMI.

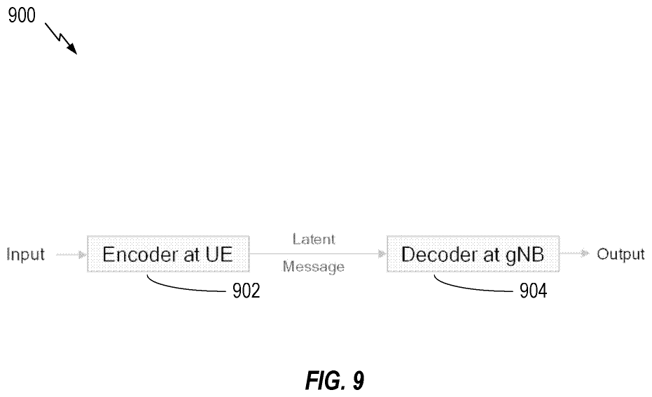

As illustrated in the example block diagram 900 of FIG. 9, in some cases, AI-based CSI feedback may replace the codebook by a CSI encoder 902 (at the UE) and a decoder 9004 at the network (e.g., gNB). In some cases, the encoder may not be needed and just the decoder may be used. In general, the encoder is analogous to the PMI searching algorithm in current systems, while the decoder is generally analogous to the PMI codebook, which is used to translate the CSI reporting bits to a PMI codeword.

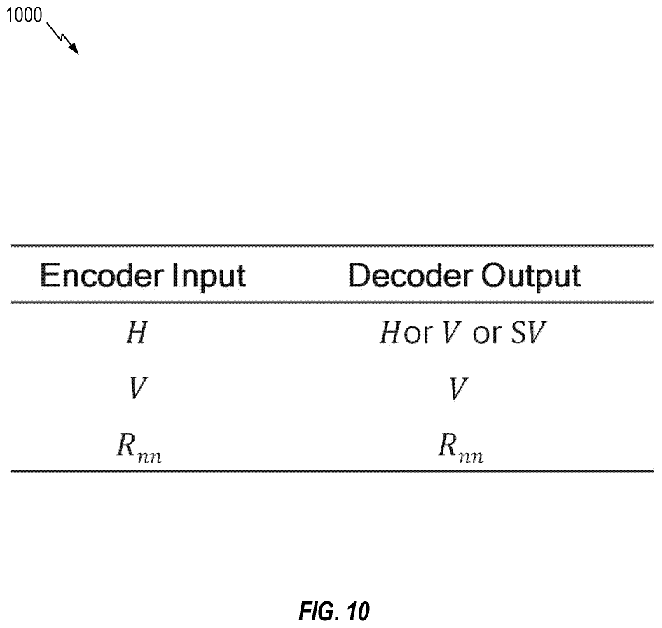

As illustrated in the table 1000 of FIG. 10, input to the decoder include a downlink channel matrix (H), downlink precoders (V), and interference covariance matrix (Rnn). Output of the decoder could be downlink channel matrix (H), transmit covariance matrix, downlink precoders (V), interference covariance matrix (Rnn), where H or V could correspond to raw channel or channel pre-whitened by UE based on its demodulation filter.

As described with respect to FIG. 8, in case of an OOD or model failure, fall back (to another algorithm/model) or re-training may be performed, or some other action may be taken to adapt to a new scenario (or cell condition) that resulted in the failure. One potential design decision is which entity (UE or network entity) should perform model monitoring and which entity should make the decision(s) regarding model retraining or switching.

Aspects of the present disclosure provide various options regarding ML model performance monitoring and decision making. Aspects provide various options, including a first option involving network side (e.g., gNB-side) ML model performance monitoring and a second option involving UE-side ML model performance monitoring. The ML model being monitored may run on the UE or gNB.

For the first option, where an entity on the network-side performs the monitoring, the decision(s) could be made at the UE or network side, with or without assistance information from the UE-side. According to the second option, with UE-side performing the monitoring, the UE may make the decision, with or without assistance information from the network (gNB-side). As used herein, the term “UE-side” may refer the UE or an entity associated with the UE, such as a UE server (in communication with the UE), a UE vendor, or model designer or model repository. Similarly, the terms “network-side” or “gNB-side” may refer to either a network entity, such as a gNB, a gNB-server, or any other element a the network side, such as a model repository.

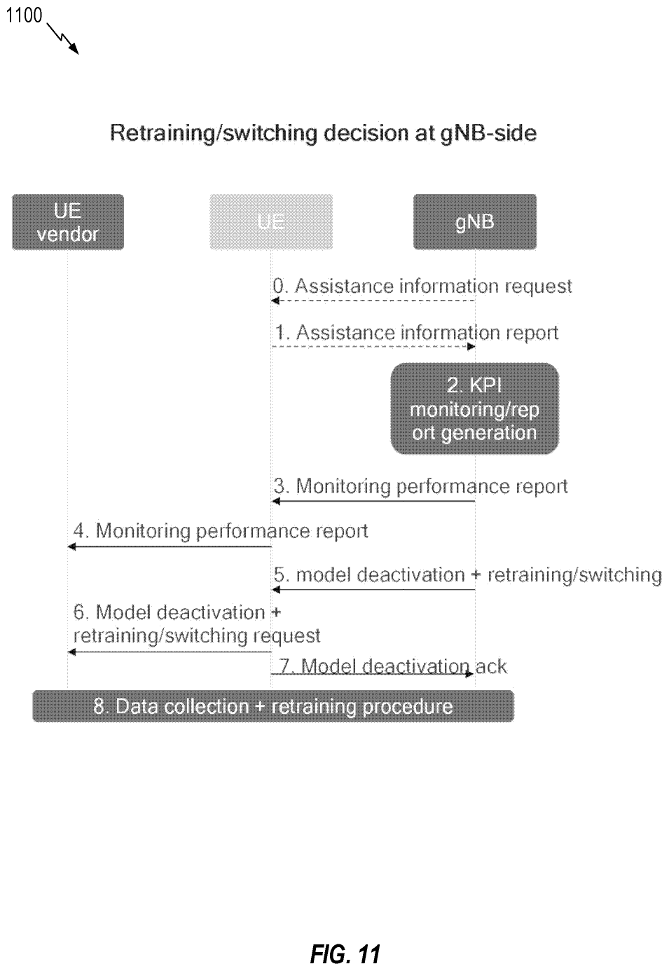

FIG. 11 illustrates a call flow diagram for network side performance monitoring, with retraining/switching decision(s) at the network side.

As illustrated, the gNB may request assistance information from the UE (step 0) and, in response, the UE may report the assistance information (step 1). Based on the monitoring, (at step 2) the gNB may generate one or more key performance indicators (KPIs) and generate a monitoring performance report (e.g., including the KPIs). The gNB transmits the monitoring performance report to the UE (at step 3). As illustrated, in some cases (at step 4), the UE may forward the report to an entity associated with the UE (e.g., a UE vendor).

If a condition is detected based on the monitoring, the gNB may decide to retrain or switch models. In such cases, (at step 5) the gNB may send a model deactivation command along with an indication that the model is to be retrained or switched. In response, the UE may send a model deactivation retraining/switching request to the UE vendor (at step 6).

In some cases, the UE may also send an acknowledgment to the gNB (at step 7) confirming the UE received the model deactivation and retraining/switching request. Finally, the entities may participate in a data collection and retraining procedure (at step 8). Exactly how this procedure is performed may depend on a number of factors, such as the type of model, whether the model is being switched or retrained, and where the model is running.

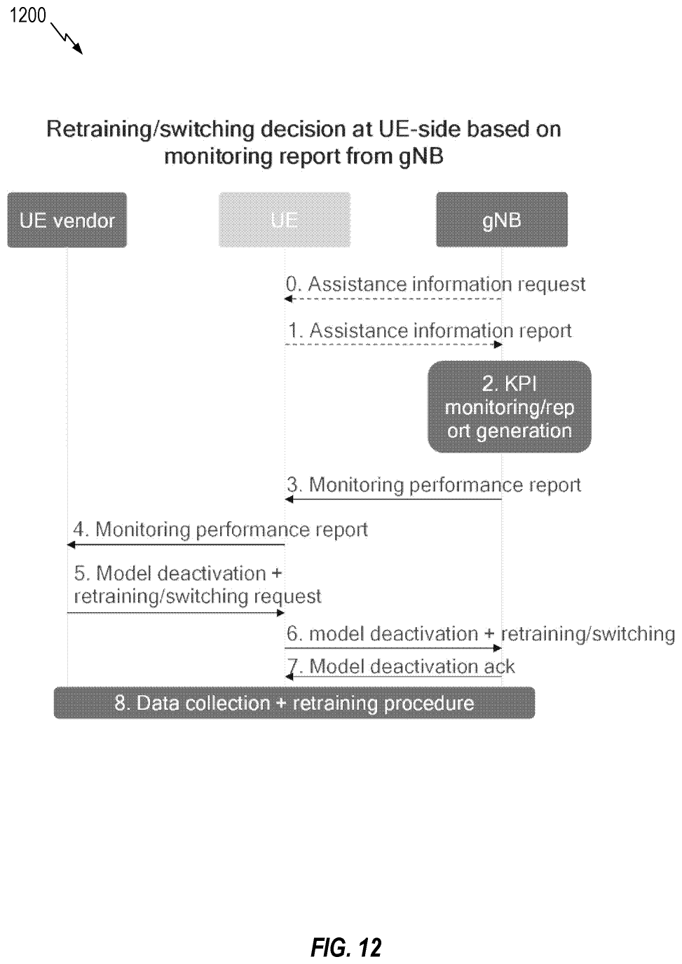

FIG. 12 illustrates a call flow diagram for network side performance monitoring, with retraining/switching decision(s) at the UE side (instead of the network side).

As illustrated, steps 0-4 may be the same as in the case of FIG. 11, where retraining/switching decision(s) at the network side. Steps 5-7 may differ, however, with the UE vendor sending the model deactivation retraining/switching request to the UE (step 5) in this case. In response, the UE may forward the model deactivation retraining/switching request to the gNB (step 6). The gNB may then acknowledge the request (at step 7). Finally, the entities may participate in the data collection and retraining procedure (at step 8). In some other instances, the UE may directly make the model retraining/switching decision without the need of the UE server. In this case, the UE can send the model deactivation retraining/switching request to the gNB. Also, the UE can initiate the model deactivation retraining/switching and data collection procedure with its UE server.

As illustrated in FIGS. 11 and 12, in some cases, the assistance information from UE (step 1 and 0) used to generate the model performance report. The type and content of assistance information may vary. For example, in some cases, the UE may provide the ground-truth (e.g., V_ideal based on actual data collected “at the ground” as opposed to predicted) to the gNB, the corresponding model ID used in the inference, and the corresponding CSI report configuration, as well as its triggering occasion or reporting occasion. In another example, the gNB may send a CSI report trigger, in step 0, to request a conventional CSI feedback using non-AI codebooks, such as Type I, Type II or eType II. The UE, in step 1, can report the corresponding PMI according to triggered CSI report in step 0.

In some cases, the gNB may compare the CSI inference (predicted) results (i.e., CSI decoder output) to the ground-truth (provided in the assistance information). The comparison can be in terms of KPI (e.g., mean square error-MSE), spectral efficiency, throughput, or cosine-similarity. In some other cases, the assistance information is a conventional non-AI (or non-ML) based CSI report, wherein the PMI is reported using non-AI/ML codebooks such as Type I, Type II or eType II. The conventional non-AI based PMI report is based on the same CSI-RS resource for channel measurement as the CSI inference results. The gNB may compare the CSI inference (predicted) results to the non-AI based on PMI. The comparison can be in terms of KPI (e.g., mean square error-MSE), spectral efficiency, throughput.

In some cases, the assistance information may be reported per-request (from the gNB at step 0). In other cases, the assistance information may be reported periodically (P) or semi-persistently (SP). As noted above, in some case, the gNB may generate the performance report without assistance information. In some cases, the gNB may use SRS measurements as ground-truth to determine an OOD/model-failure. In some cases, the gNB may have limited information (e.g., {z, Vhat}) and may use an AI/ML-based approach to determine whether the {z, Vhat} is “in-distribution” to a previously used training set {z_training, Vhat_training} or OOD (e.g., using a separate NN model than what is being monitored or based on statistics inside the decoder). Here, z and z_training denotee the latent information output by the CSI encoder and input to the CSI decoder, while Vhat and Vhat_training denote the CSI decoder output.

In some cases, the report information in the performance report may indicate performance gap to ground-truth or difference compared to a baseline PMI codebook (such as Type I, Type II or eType II) or may indicate general system performance. In some cases, the report information may contain statistics per individual inference or per multiple inference. The report information may also contain likelihood fit into each existing models (e.g., {0.5, 0.3, 0.2}) indicating the possible fit into one of three models 1, 2, 3 respectively. Generating this information may require a separate NN running at gNB-side that outputs the possibility. The performance report may be sent based on an event-trigger, may be sent periodically, or may be sent semi-persistently.

The decisions (e.g., at step 5-6) at the gNB or UE-side for model retraining/switching may be based on the monitoring and the generated performance report. Based on these, the gNB or UE-server may decide whether to stay on a current model (in which case no additional step 5-7 may be taken) or may determine that the current model has failed and send a model deactivation request.

In case the failed samples fit in other existing models, a model switching decision may be made (e.g., to update the model with the corresponding ID, based on the fit, in addition to model deactivation). Otherwise (e.g., if not fit), the decision making entity may send a model retraining request (e.g., in addition to model deactivation).

For a decision at gNB-side, if switching is determined, the signaling may also include information (e.g., KPI) of the model, for example, with the updated model ID. If retraining is decided, the signaling may also include information on the failed samples (e.g., delay spread, average delay, average gain, Doppler, spatial information, such as angle of arrival-AoA, angle of departure-AoD, zenith angle of arrival-ZoA, and zenith angle of departure-ZoD). A signaling mechanism for steps 5 and 6 may be the same as for steps 3 and 4 (e.g., RRC or MAC layer signaling). The signaling for steps 5 and 6 can be via the same signalings for steps 3 and 4.

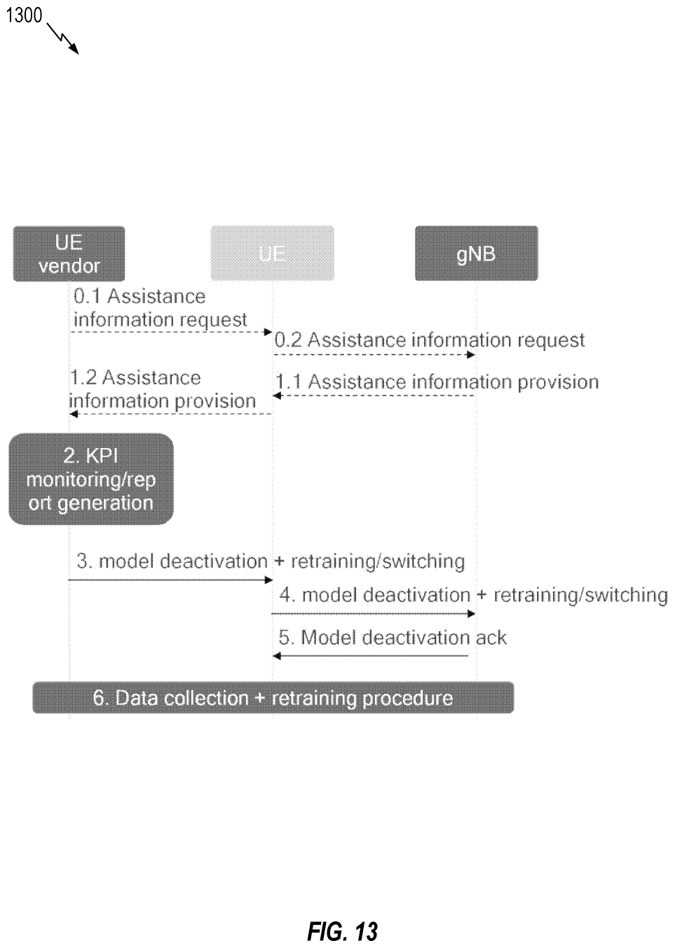

For a decision at the UE-side, after sending an initial deactivation request, the UE side may refrain from sending a subsequent deactivation request within a timer period. For deactivation acknowledgment, at step 7, for a gNB-side decision, the UE may send an acknowledgment to the deactivation command, indicating that successful reception of the command and start retraining/switching. For a UE-side decision, the gNB may either send ACK via a dedicated signaling or via a RRC reconfiguration of the AI/ML model (in other words, the UE may treat the RRC reconfiguration as an acknowledgment the request to switch was received). FIG. 13 illustrates a call flow diagram for UE side performance monitoring. As noted above, in this case, retraining/switching decision(s) may also be made at the UE side.

As illustrated, step 0 may include two steps, with the UE vendor sending a request for assistance information (at step 0.1), which the UE may forward to the gNB (at step 0.2). For step 1, the gNB may send provisions for the assistance information, at step 1.1, and the UE may forward this to the UE vendor (at step 1.2). At step 2, the UE vendor may generate one or more KPIs and generate a monitoring performance report (e.g., including the KPIs). The UE vendor transmits the monitoring performance report to the UE (at step 3). In some cases, the UE may directly send the assistance information request to the gNB without involvement of the UE vendor. In some cases, once the UE receives the assistance information from the gNB, the UE may use it to generate one or more KPIs and generate a monitoring performance report (e.g., including the KPIs).

As illustrated, based on the monitoring performance report, the UE-side (either UE or UE vendor) may decide to retrain or switch models. In such cases, (at step 4) the UE may send the gNB a model deactivation command along with an indication that the model is to be retrained or switched. The gNB may acknowledge the request (at step 5). Finally, the entities may participate in the data collection and retraining procedure (at step 6).

For UE side performance monitoring, assistance information from the gNB (at step 0 and 1) may be used to generate the performance monitoring report. In some cases, the gNB may provide the inference results to UE (e.g., the CSI decoder output), the corresponding model ID used in the inference, the corresponding CSI report configuration, as well as its triggering occasion or reporting occasion. In such cases, the UE may compare the CSI inference results (i.e., CSI decoder output) to the ground-truth or compare it to a baseline CSI codebook. The comparison may be in terms of KPI (e.g., MSE, spectral efficiency, throughput, cosine-similarity).

The assistance information report can be sent per-request from UE-side (step 0), sent periodically, or sent semi-persistently. In some cases, the UE-side may be able generate the performance report without assistance information. If UE has CSI decoder, the UE may be able to compare the inference results to the ground-truth or to a baseline CSI codebook. If the UE has limited information, such as only {H, Z}, the UE may use an AI/ML-based approach to determine the {H,z} is “in-distribution” to a {H_training, z_training} or OOD (e.g., using a separate neural network based model or based on statistics of the latent inside the CSI encoder). Here, z denotes the latent information output by the CSI encoder and input to the CSI decoder, while H denotes the input to the CSI encoder.

The report information (at step 2 and 3) may include performance gap to ground-truth, general system performance, or statistics per individual inference or per multiple inference. In some cases, The report information may include likelihood fit into each existing models (e.g., {0.5, 0.3, 0.2} possibility fit into three candidate models 1, 2, 3, respectively). This approach may involve a separate model (e.g., NN) running at the gNB-side which may be configured to output the possibility information. In some cases, the performance report can be sent based on an event-trigger, may be sent periodically, or may be sent semi-persistently.

The UE-side decision regarding model retraining/switching may be based on its own monitoring and the generated performance report. Based on this information, the UE-vendor (e.g., UE server) or UE may decide whether to stay on a current model (in which steps 5-7 are not performed) or whether a current model fails (e.g., leading to sending a model deactivation request). In some cases, if the failed samples fit in another existing model, a model switching decision may be made and a model switching request may include an indication of an updated model, for example, with a corresponding model ID in addition to the model deactivation. If there is no fit determined, the UE or UE vendor may send a model retraining request (e.g., in addition to model deactivation) to the gNB side. After sending a first deactivation request, the UE may refrain from sending a second deactivation request, for example, within a timer period.

In some other cases, the UE or UE vendor may send the performance report to the gNB side. The gNB may make the decision of model deactivation, retraining/switching. Then the gNB may send command to deactivate the current model to UE. The model retraining/switching and data collection can be initiated by either UE side or gNB side.

The deactivation acknowledgment (step 7) may be sent in any suitable type of signaling. For example, the acknowledgment may be sent via dedicated signaling or (implicitly) via an RRC reconfiguration of the AI/ML model.

### Example Operations of User Equipment

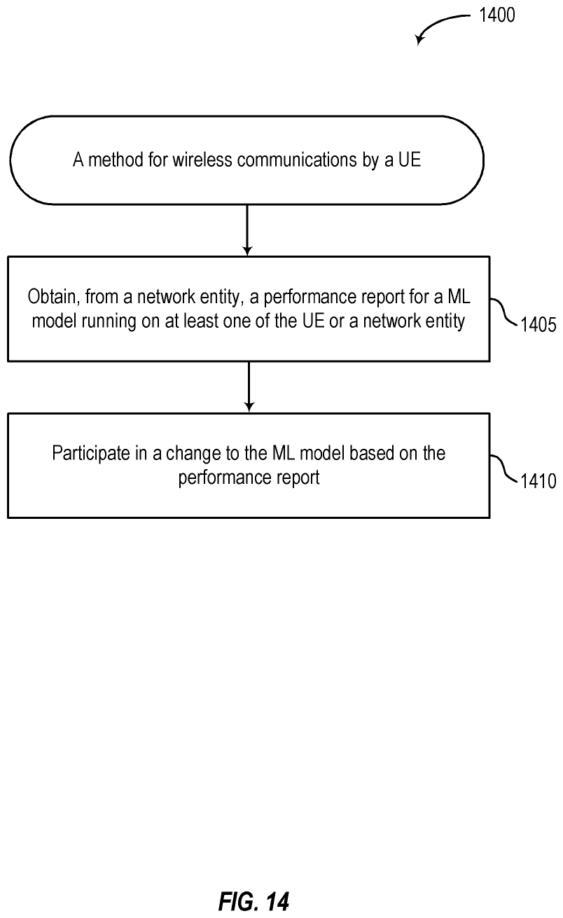

FIG. 14 shows an example of a method 1400 for wireless communications by a UE, such as UE 104 of FIGS. 1 and 3.

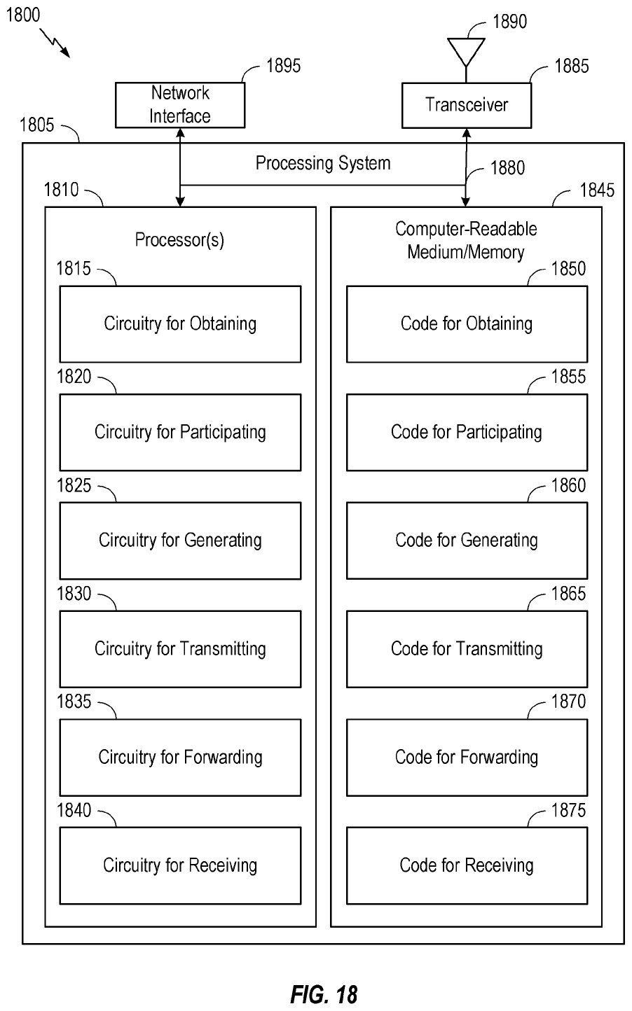

Method 1400 begins at step 1405 with obtaining, from a network entity, a performance report for a ML model running on at least one of the UE or a network entity. In some cases, the operations of this step refer to, or may be performed by, circuitry for obtaining and/or code for obtaining as described with reference to FIG. 18.

Method 1400 then proceeds to step 1410 with participating in a change to the ML model based on the performance report. In some cases, the operations of this step refer to, or may be performed by, circuitry for participating and/or code for participating as described with reference to FIG. 18.

In some aspects, the method 1400 further includes forwarding the performance report to an entity associated with the UE. In some cases, the operations of this step refer to, or may be performed by, circuitry for forwarding and/or code for forwarding as described with reference to FIG. 18.

In some aspects, the method 1400 further includes transmitting, to the network entity, assistance information to assist the network entity in generating the performance report. In some cases, the operations of this step refer to, or may be performed by, circuitry for transmitting and/or code for transmitting as described with reference to FIG. 18.

In some aspects, the assistance information comprises at least one of: ground truth information collected by the UE, an ID of the ML model, a corresponding CSI report configuration, and information regarding the CSI report configuration triggering occasion or reporting occasion.

In some aspects, the assistance information is transmitted in response to a request from the network entity, or periodically, or semi-persistently.

In some aspects, the performance report indicates at least one of: an indication of a difference in predicted and actual performance, general system performance, statistics per individual inference by the ML model, or statistics per multiple inferences by the ML model.

In some aspects, the performance report indicates a likelihood fit into different ML models.

In some aspects, the participating in the change to the ML model based on the performance report comprises participating in retraining the ML model or switching to a different ML model.

In some aspects, the method 1400 further includes receiving an indication, from the network entity, to retrain the ML model or switch to the different ML model. In some cases, the operations of this step refer to, or may be performed by, circuitry for receiving and/or code for receiving as described with reference to FIG. 18.

In some aspects, the indication comprises a deactivation of the ML model.

In some aspects, the method 1400 further includes forwarding the indication to an entity associated with the UE. In some cases, the operations of this step refer to, or may be performed by, circuitry for forwarding and/or code for forwarding as described with reference to FIG. 18.

In some aspects, if the indication is to retrain the ML model, the indication also includes information for the retraining.

In some aspects, if the indication is to switch to the different ML model, the indication also includes an identification of the different ML model.

In some aspects, the method 1400 further includes transmitting, to the network entity, an acknowledgment of receiving the indication. In some cases, the operations of this step refer to, or may be performed by, circuitry for transmitting and/or code for transmitting as described with reference to FIG. 18.

In some aspects, the method 1400 further includes transmitting an indication, to the network entity, to retrain the ML model or switch to the different ML model. In some cases, the operations of this step refer to, or may be performed by, circuitry for transmitting and/or code for transmitting as described with reference to FIG. 18.

In some aspects, the indication comprises a deactivation of the ML model.

In some aspects, the method 1400 further includes, before transmitting the indication to the network entity, receiving the indication from the entity associated with the UE to retrain the current ML model or switch to the different ML model. In some cases, the operations of this step refer to, or may be performed by, circuitry for receiving and/or code for receiving as described with reference to FIG. 18.

In some aspects, if the indication is to retrain the ML model, the indication also includes information for the retraining.

In some aspects, if the indication is to switch to the different ML model, the indication also includes an identification of the different ML model.

In one aspect, method 1400, or any aspect related to it, may be performed by an apparatus, such as communications device 1800 of FIG. 18, which includes various components operable, configured, or adapted to perform the method 1400. Communications device 1800 is described below in further detail.

Note that FIG. 14 is just one example of a method, and other methods including fewer, additional, or alternative steps are possible consistent with this disclosure.

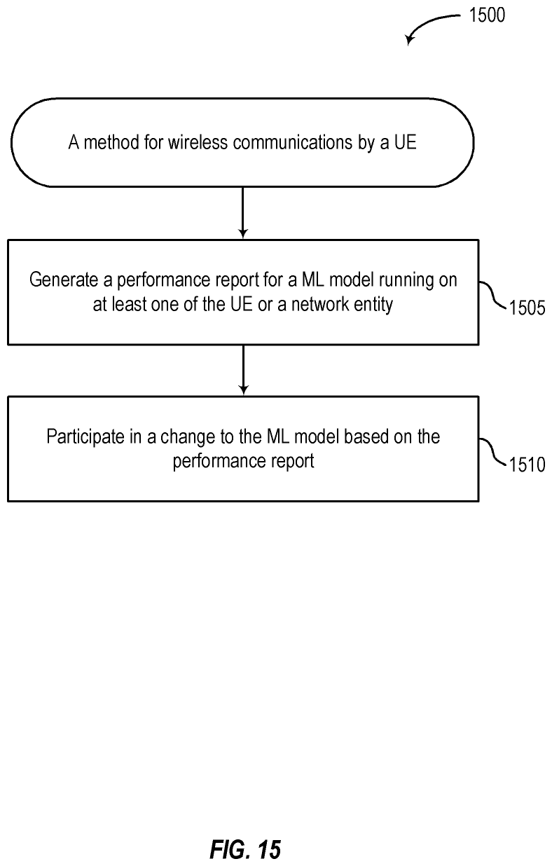

FIG. 15 shows an example of a method 1500 for wireless communications by a UE, such as UE 104 of FIGS. 1 and 3.

Method 1500 begins at step 1505 with generating a performance report for a ML model running on at least one of the UE or a network entity. In some cases, the operations of this step refer to, or may be performed by, circuitry for generating and/or code for generating as described with reference to FIG. 18.

Method 1500 then proceeds to step 1510 with participating in a change to the ML model based on the performance report. In some cases, the operations of this step refer to, or may be performed by, circuitry for participating and/or code for participating as described with reference to FIG. 18.

In some aspects, the method 1500 further includes forwarding the performance report to a network entity. In some cases, the operations of this step refer to, or may be performed by, circuitry for forwarding and/or code for forwarding as described with reference to FIG. 18.

In some aspects, the method 1500 further includes receiving, from the network entity, assistance information to assist in generating the performance report. In some cases, the operations of this step refer to, or may be performed by, circuitry for receiving and/or code for receiving as described with reference to FIG. 18.

In some aspects, the assistance information comprises at least one of: ground truth information collected by the UE, an ID of the ML model, a corresponding CSI report configuration, and information regarding the CSI report configuration triggering occasion or reporting occasion.

In some aspects, the assistance information is received periodically, or semi-persistently, or in response to a request transmitted to the network entity, by the UE or UE vendor.

In some aspects, the performance report indicates at least one of: an indication of a difference in predicted and actual performance, general system performance, statistics per individual inference by the ML model, or statistics per multiple inferences by the ML model.

In some aspects, the performance report indicates a likelihood fit into different ML models.

In some aspects, the participating in the change to the ML model based on the performance report comprises participating in retraining the ML model or switching to a different ML model.

In some aspects, the method 1500 further includes transmitting an indication, to the network entity, to retrain the ML model or switch to the different ML model. In some cases, the operations of this step refer to, or may be performed by, circuitry for transmitting and/or code for transmitting as described with reference to FIG. 18.

In some aspects, the method 1500 further includes, before transmitting the indication to the network entity, receiving the indication from the entity associated with the UE, to retrain the ML model or switch to the different ML model. In some cases, the operations of this step refer to, or may be performed by, circuitry for receiving and/or code for receiving as described with reference to FIG. 18.

In some aspects, if the indication is to retrain the ML model, the indication also includes information for the retraining.

In some aspects, if the indication is to switch to the different ML model, the indication also includes an identification of the different ML model.

In some aspects, the indication comprises a deactivation of the ML model.

In some aspects, the method 1500 further includes receiving an indication, from the network entity, to retrain the ML model or switch to the different ML model. In some cases, the operations of this step refer to, or may be performed by, circuitry for receiving and/or code for receiving as described with reference to FIG. 18.

In some aspects, the indication comprises a deactivation of the ML model.

In one aspect, method 1500, or any aspect related to it, may be performed by an apparatus, such as communications device 1800 of FIG. 18, which includes various components operable, configured, or adapted to perform the method 1500. Communications device 1800 is described below in further detail.

Note that FIG. 15 is just one example of a method, and other methods including fewer, additional, or alternative steps are possible consistent with this disclosure.

### Example Operations of Network Entities

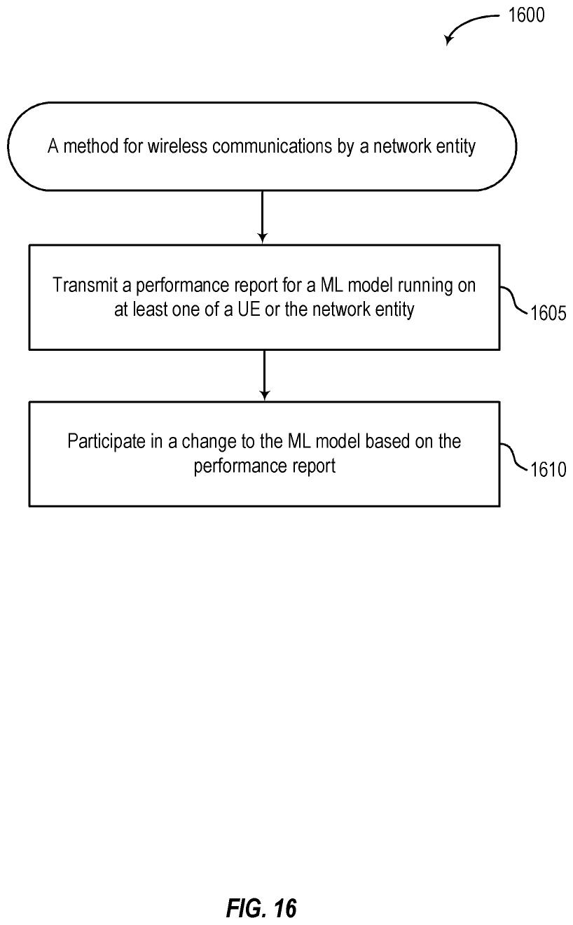

FIG. 16 shows an example of a method 1600 for wireless communications by a network entity, such as BS 102 of FIGS. 1 and 3, or a disaggregated base station as discussed with respect to FIG. 2.

Method 1600 begins at step 1605 with transmitting a performance report for a ML model running on at least one of a UE or the network entity. In some cases, the operations of this step refer to, or may be performed by, circuitry for transmitting and/or code for transmitting as described with reference to FIG. 18.

Method 1600 then proceeds to step 1610 with participating in a change to the ML model based on the performance report. In some cases, the operations of this step refer to, or may be performed by, circuitry for participating and/or code for participating as described with reference to FIG. 18.

In some aspects, the method 1600 further includes receiving assistance information generated by the UE; and using the assistance information when generating the performance report. In some cases, the operations of this step refer to, or may be performed by, circuitry for receiving and/or code for receiving as described with reference to FIG. 18.

In some aspects, the assistance information comprises at least one of: ground truth information collected by the UE, an ID of the ML model, a corresponding CSI report configuration, and information regarding the CSI report configuration triggering occasion or reporting occasion.

In some aspects, the assistance information is received in response to a request from the network entity, or periodically, or semi-persistently.

In some aspects, the performance report indicates at least one of: an indication of a difference in predicted and actual performance, general system performance, statistics per individual inference by the ML model, or statistics per multiple inferences by the ML model.

In some aspects, the performance report indicates a likelihood fit into different ML models.

In some aspects, the participating in the change to the ML model based on the performance report comprises transmitting an indication, for the UE to retrain the ML model or switch to the different ML model.

In some aspects, the indication comprises a deactivation of the ML model.

In some aspects, if the indication is to retrain the ML model, the indication also includes information for the retraining.

In some aspects, if the indication is to switch to the different ML model, the indication also includes an identification of the different ML model.

In some aspects, the method 1600 further includes receiving an acknowledgment of the UE receiving the indication. In some cases, the operations of this step refer to, or may be performed by, circuitry for receiving and/or code for receiving as described with reference to FIG. 18.

In some aspects, the method 1600 further includes receiving an indication, from the UE, to retrain the ML model or switch to the different ML model. In some cases, the operations of this step refer to, or may be performed by, circuitry for receiving and/or code for receiving as described with reference to FIG. 18.

In some aspects, the indication comprises a deactivation of the ML model.

In one aspect, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative steps are possible consistent with this disclosure.

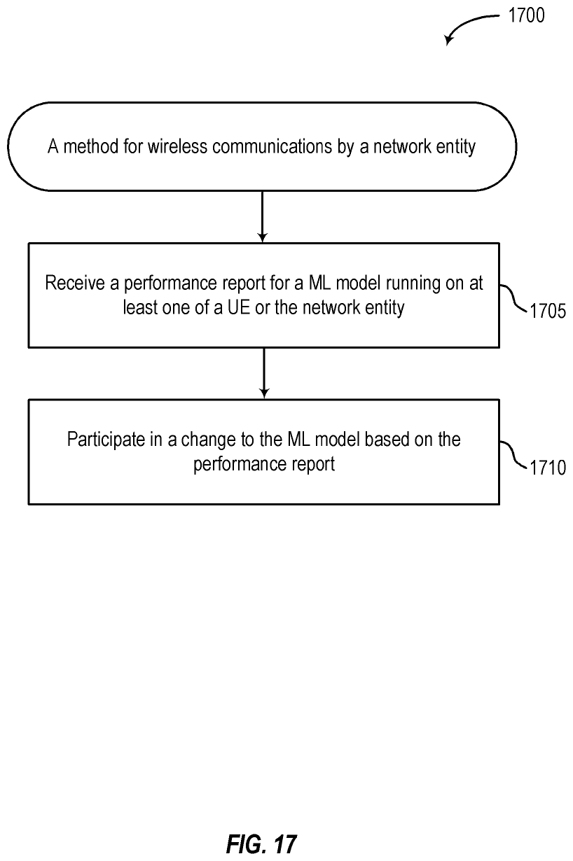

FIG. 17 shows an example of a method 1700 for wireless communications by a network entity, such as BS 102 of FIGS. 1 and 3, or a disaggregated base station as discussed with respect to FIG. 2.

Method 1700 begins at step 1705 with receiving a performance report for a ML model running on at least one of a UE or the network entity. In some cases, the operations of this step refer to, or may be performed by, circuitry for receiving and/or code for receiving as described with reference to FIG. 18.

Method 1700 then proceeds to step 1710 with participating in a change to the ML model based on the performance report. In some cases, the operations of this step refer to, or may be performed by, circuitry for participating and/or code for participating as described with reference to FIG. 18.

In some aspects, the method 1700 further includes transmitting assistance information to assist the UE in generating the performance report. In some cases, the operations of this step refer to, or may be performed by, circuitry for transmitting and/or code for transmitting as described with reference to FIG. 18.

In some aspects, the assistance information comprises at least one of: ground truth information collected by the UE, an ID of the ML model, a corresponding CSI report configuration, and information regarding the CSI report configuration triggering occasion or reporting occasion.

In some aspects, the assistance information is received periodically, or semi-persistently, or in response to a request transmitted to the network entity, by the UE or UE vendor.

In some aspects, the performance report indicates at least one of: an indication of a difference in predicted and actual performance, general system performance, statistics per individual inference by the ML model, or statistics per multiple inferences by the ML model.

In some aspects, the performance report indicates a likelihood fit into different ML models.

In some aspects, the participating in the change to the ML model based on the performance report comprises participating in retraining the ML model or switching to a different ML model.

In some aspects, the method 1700 further includes transmitting an indication, to the network entity, to retrain the ML model or switch to the different ML model. In some cases, the operations of this step refer to, or may be performed by, circuitry for transmitting and/or code for transmitting as described with reference to FIG. 18.

In some aspects, if the indication is to retrain the ML model, the indication also includes information for the retraining.

In some aspects, if the indication is to switch to the different ML model, the indication also includes an identification of the different ML model.

In some aspects, the indication comprises a deactivation of the ML model.

In some aspects, the method 1700 further includes transmitting an indication for the UE to retrain the ML model or switch to the different ML model. In some cases, the operations of this step refer to, or may be performed by, circuitry for transmitting and/or code for transmitting as described with reference to FIG. 18.

In some aspects, the indication comprises a deactivation of the ML model.

In one aspect, method 1700, or any aspect related to it, may be performed by an apparatus, such as communications device 1800 of FIG. 18, which includes various components operable, configured, or adapted to perform the method 1700. Communications device 1800 is described below in further detail.

Note that FIG. 17 is just one example of a method, and other methods including fewer, additional, or alternative steps are possible consistent with this disclosure.

### Example Communications Device

FIG. 18 depicts aspects of an example communications device 1800. In some aspects, communications device 1800 is a user equipment, such as UE 104 described above with respect to FIGS. 1 and 3. In some aspects, communications device 1800 is a network entity, such as BS 102 of FIGS. 1 and 3, or a disaggregated base station as discussed with respect to FIG. 2.

The communications device 1800 includes a processing system 1805 coupled to the transceiver 1885 (e.g., a transmitter and/or a receiver). In some aspects (e.g., when communications device 1800 is a network entity), processing system 1805 may be coupled to a network interface 1895 that is configured to obtain and send signals for the communications device 1800 via communication link(s), such as a backhaul link, midhaul link, and/or fronthaul link as described herein, such as with respect to FIG. 2. The transceiver 1885 is configured to transmit and receive signals for the communications device 1800 via the antenna 1890, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. In various aspects, one or more processors 1810 may be representative of one or more of receive processor 338, transmit processor 320, TX MIMO processor 330, and/or controller/processor 340, as described with respect to FIG. 3. The one or more processors 1810 are coupled to a computer-readable medium/memory 1845 via a bus 1880. In certain aspects, the computer-readable medium/memory 1845 is configured to store instructions (e.g., computer-executable code) that when executed by the one or more processors 1810, cause the one or more processors 1810 to perform: the method 1400 described with respect to FIG. 14, or any aspect related to it; the method 1500 described with respect to FIG. 15, or any aspect related to it; the method 1600 described with respect to FIG. 16, or any aspect related to it; and/or the method 1700 described with respect to FIG. 17, or any aspect related to it. Note that reference to a processor performing a function of communications device 1800 may include one or more processors 1810 performing that function of communications device 1800.

In the depicted example, computer-readable medium/memory 1845 stores code (e.g., executable instructions), such as code for obtaining 1850, code for participating 1855, code for generating 1860, code for transmitting 1865, code for forwarding 1870, and code for receiving 1875. Processing of the code for obtaining 1850, code for participating 1855, code for generating 1860, code for transmitting 1865, code for forwarding 1870, and code for receiving 1875 may cause the communications device 1800 to perform: the method 1400 described with respect to FIG. 14, or any aspect related to it; the method 1500 described with respect to FIG. 15, or any aspect related to it; the method 1600 described with respect to FIG. 16, or any aspect related to it; and/or the method 1700 described with respect to FIG. 17, or any aspect related to it.

The one or more processors 1810 include circuitry configured to implement (e.g., execute) the code stored in the computer-readable medium/memory 1845, including circuitry such as circuitry for obtaining 1815, circuitry for participating 1820, circuitry for generating 1825, circuitry for transmitting 1830, circuitry for forwarding 1835, and circuitry for receiving 1840. Processing with circuitry for obtaining 1815, circuitry for participating 1820, circuitry for generating 1825, circuitry for transmitting 1830, circuitry for forwarding 1835, and circuitry for receiving 1840 may cause the communications device 1800 to perform: the method 1400 described with respect to FIG. 14, or any aspect related to it; the method 1500 described with respect to FIG. 15, or any aspect related to it; the method 1600 described with respect to FIG. 16, or any aspect related to it; and/or the method 1700 described with respect to FIG. 17, or any aspect related to it.

Various components of the communications device 1800 may provide means for performing: the method 1400 described with respect to FIG. 14, or any aspect related to it; the method 1500 described with respect to FIG. 15, or any aspect related to it; the method 1600 described with respect to FIG. 16, or any aspect related to it; and/or the method 1700 described with respect to FIG. 17, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1885 and the antenna 1890 of the communications device 1800 in FIG. 18. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1885 and the antenna 1890 of the communications device 1800 in FIG. 18.

### EXAMPLE CLAUSES

Implementation examples are described in the following numbered clauses:

Clause 1: A method of wireless communications by a UE, comprising: obtaining, from a network entity, a performance report for a ML model running on at least one of the UE or a network entity; and participating in a change to the ML model based on the performance report.

Clause 2: The method of Clause 1, further comprising forwarding the performance report to an entity associated with the UE.

Clause 3: The method of any one of Clauses 1 and 2, further comprising transmitting, to the network entity, assistance information to assist the network entity in generating the performance report.

Clause 4: The method of Clause 3, wherein the assistance information comprises at least one of: ground truth information collected by the UE, an ID of the ML model, a corresponding CSI report configuration, and information regarding the CSI report configuration triggering occasion or reporting occasion.

Clause 5: The method of Clause 3, wherein the assistance information is transmitted in response to a request from the network entity, or periodically, or semi-persistently.

Clause 6: The method of any one of Clauses 1-5, wherein the performance report indicates at least one of: an indication of a difference in predicted and actual performance, general system performance, statistics per individual inference by the ML model, or statistics per multiple inferences by the ML model.

Clause 7: The method of any one of Clauses 1-6, wherein the performance report indicates a likelihood fit into different ML models.

Clause 8: The method of any one of Clauses 1-7, wherein the participating in the change to the ML model based on the performance report comprises participating in retraining the ML model or switching to a different ML model.

Clause 9: The method of Clause 8, further comprising receiving an indication, from the network entity, to retrain the ML model or switch to the different ML model.

Clause 10: The method of Clause 9, wherein the indication comprises a deactivation of the ML model.

Clause 11: The method of Clause 9, further comprising forwarding the indication to an entity associated with the UE.

Clause 12: The method of Clause 9, wherein, if the indication is to retrain the ML model, the indication also includes information for the retraining.

Clause 13: The method of Clause 9, wherein, if the indication is to switch to the different ML model, the indication also includes an identification of the different ML model.

Clause 14: The method of Clause 9, further comprising transmitting, to the network entity, an acknowledgment of receiving the indication.

Clause 15: The method of Clause 8, further comprising transmitting an indication, to the network entity, to retrain the ML model or switch to the different ML model.

Clause 16: The method of Clause 15, wherein the indication comprises a deactivation of the ML model.

Clause 17: The method of Clause 15, further comprising, before transmitting the indication to the network entity, receiving the indication from the entity associated with the UE to retrain the current ML model or switch to the different ML model.

Clause 18: The method of Clause 15, wherein, if the indication is to retrain the ML model, the indication also includes information for the retraining.

Clause 19: The method of Clause 15, wherein, if the indication is to switch to the different ML model, the indication also includes an identification of the different ML model.

Clause 20: A method of wireless communications by a UE, comprising: generating a performance report for a ML model running on at least one of the UE or a network entity; and participating in a change to the ML model based on the performance report.

Clause 21: The method of Clause 20, further comprising forwarding the performance report to a network entity.

Clause 22: The method of any one of Clauses 20-21, further comprising receiving, from the network entity, assistance information to assist in generating the performance report.

Clause 23: The method of Clause 22, wherein the assistance information comprises at least one of: ground truth information collected by the UE, an ID of the ML model, a corresponding CSI report configuration, and information regarding the CSI report configuration triggering occasion or reporting occasion.

Clause 24: The method of Clause 22, wherein the assistance information is received periodically, or semi-persistently, or in response to a request transmitted to the network entity, by the UE or UE vendor.

Clause 25: The method of any one of Clauses 20-24, wherein the performance report indicates at least one of: an indication of a difference in predicted and actual performance, general system performance, statistics per individual inference by the ML model, or statistics per multiple inferences by the ML model.

Clause 26: The method of any one of Clauses 20-25, wherein the performance report indicates a likelihood fit into different ML models.

Clause 27: The method of any one of Clauses 20-26, wherein the participating in the change to the ML model based on the performance report comprises participating in retraining the ML model or switching to a different ML model.

Clause 28: The method of Clause 27, further comprising transmitting an indication, to the network entity, to retrain the ML model or switch to the different ML model.

Clause 29: The method of Clause 28, further comprising, before transmitting the indication to the network entity, receiving the indication from the entity associated with the UE, to retrain the ML model or switch to the different ML model.

Clause 30: The method of Clause 28, wherein, if the indication is to retrain the ML model, the indication also includes information for the retraining.

Clause 31: The method of Clause 28, wherein, if the indication is to switch to the different ML model, the indication also includes an identification of the different ML model.

Clause 32: The method of Clause 31, wherein the indication comprises a deactivation of the ML model.

Clause 33: The method of Clause 27, further comprising receiving an indication, from the network entity, to retrain the ML model or switch to the different ML model.

Clause 34: The method of Clause 33, wherein the indication comprises a deactivation of the ML model.

Clause 35: A method of wireless communications by a network entity, comprising: transmitting a performance report for a ML model running on at least one of a UE or the network entity; and participating in a change to the ML model based on the performance report.

Clause 36: The method of Clause 35, further comprising: receiving assistance information generated by the UE; and using the assistance information when generating the performance report.

Clause 37: The method of Clause 36, wherein the assistance information comprises at least one of: ground truth information collected by the UE, an ID of the ML model, a corresponding CSI report configuration, and information regarding the CSI report configuration triggering occasion or reporting occasion.

Clause 38: The method of Clause 37, wherein the assistance information is received in response to a request from the network entity, or periodically, or semi-persistently.

Clause 39: The method of any one of Clauses 35-38, wherein the performance report indicates at least one of: an indication of a difference in predicted and actual performance, general system performance, statistics per individual inference by the ML model, or statistics per multiple inferences by the ML model.

Clause 40: The method of any one of Clauses 35-39, wherein the performance report indicates a likelihood fit into different ML models.

Clause 41: The method of any one of Clauses 35-40, wherein the participating in the change to the ML model based on the performance report comprises transmitting an indication, for the UE to retrain the ML model or switch to the different ML model.

Clause 42: The method of Clause 41, wherein the indication comprises a deactivation of the ML model.

Clause 43: The method of Clause 41, wherein, if the indication is to retrain the ML model, the indication also includes information for the retraining.

Clause 44: The method of Clause 41, wherein, if the indication is to switch to the different ML model, the indication also includes an identification of the different ML model.

Clause 45: The method of Clause 41, further comprising receiving an acknowledgment of the UE receiving the indication.

Clause 46: The method of Clause 45, further comprising receiving an indication, from the UE, to retrain the ML model or switch to the different ML model.

Clause 47: The method of Clause 46, wherein the indication comprises a deactivation of the ML model.

Clause 48: A method of wireless communications by a network entity, comprising: receiving a performance report for a ML model running on at least one of a UE or the network entity; and participating in a change to the ML model based on the performance report.

Clause 49: The method of Clause 48, further comprising transmitting assistance information to assist the UE in generating the performance report.

Clause 50: The method of Clause 49, wherein the assistance information comprises at least one of: ground truth information collected by the UE, an ID of the ML model, a corresponding CSI report configuration, and information regarding the CSI report configuration triggering occasion or reporting occasion.

Clause 51: The method of Clause 49, wherein the assistance information is received periodically, or semi-persistently, or in response to a request transmitted to the network entity, by the UE or UE vendor.

Clause 52: The method of any one of Clauses 48-51, wherein the performance report indicates at least one of: an indication of a difference in predicted and actual performance, general system performance, statistics per individual inference by the ML model, or statistics per multiple inferences by the ML model.

Clause 53: The method of Clause 52, wherein the performance report indicates a likelihood fit into different ML models.

Clause 54: The method of Clause 52, wherein the participating in the change to the ML model based on the performance report comprises participating in retraining the ML model or switching to a different ML model.

Clause 55: The method of Clause 54, further comprising transmitting an indication, to the network entity, to retrain the ML model or switch to the different ML model.

Clause 56: The method of Clause 55, wherein, if the indication is to retrain the ML model, the indication also includes information for the retraining.

Clause 57: The method of Clause 55, wherein, if the indication is to switch to the different ML model, the indication also includes an identification of the different ML model.

Clause 58: The method of Clause 57, wherein the indication comprises a deactivation of the ML model.

Clause 59: The method of any one of Clauses 48-58, further comprising transmitting an indication for the UE to retrain the ML model or switch to the different ML model.

Clause 60: The method of Clause 59, wherein the indication comprises a deactivation of the ML model.

Clause 61: An apparatus, comprising: a memory comprising executable instructions; and a processor configured to execute the executable instructions and cause the apparatus to perform a method in accordance with any one of Clauses 1-60.

Clause 62: An apparatus, comprising means for performing a method in accordance with any one of Clauses 1-60.

Clause 63: A non-transitory computer-readable medium comprising executable instructions that, when executed by a processor of an apparatus, cause the apparatus to perform a method in accordance with any one of Clauses 1-60.

Clause 64: A computer program product embodied on a computer-readable storage medium comprising code for performing a method in accordance with any one of Clauses 1-60.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communications by a user equipment (UE), comprising:
obtaining, from a network entity, a performance report for a machine learning (ML) model running on at least one of the UE or a network entity; and
participating in a change to the ML model based on the performance report.

2. The method of claim 1, further comprising forwarding the performance report to an entity associated with the UE.

3. The method of claim 1, further comprising transmitting, to the network entity, assistance information to assist the network entity in generating the performance report.

4. The method of claim 3, wherein the assistance information comprises at least one of: ground truth information collected by the UE, an ID of the ML model, a corresponding channel station information (CSI) report configuration, information regarding the CSI report configuration triggering occasion or reporting occasion, or a baseline CSI report using non-ML based precoder matrix indicator (PMI) codebooks, wherein the baseline CSI report is based on the same CSI reference signal (CSI-RS) resource for channel measurement as an ML-based CSI report.

5. The method of claim 3, wherein the assistance information is transmitted in response to a request from the network entity, or periodically, or semi-persistently.

6. The method of claim 1, wherein the performance report indicates at least one of: an indication of a difference in predicted and actual performance, general system performance, statistics per individual inference by the ML model, or statistics per multiple inferences by the ML model.

7. The method of claim 1, wherein the performance report indicates a likelihood fit into different ML models.

8. The method of claim 1, wherein participating in a change to the ML model based on the performance report comprises participating in retraining the ML model or switching to a different ML model.

9. The method of claim 8, further comprising receiving an indication, from the network entity, to retrain the ML model or switch to the different ML model.

10. The method of claim 9, wherein the indication comprises a deactivation of the ML model.

11. The method of claim 9, further comprising forwarding the indication to an entity associated with the UE.

12. The method of claim 9, wherein, if the indication is to retrain the ML model, the indication also includes information for the retraining.

13. The method of claim 9, wherein, if the indication is to switch to the different ML model, the indication also includes an identification of the different ML model.

14. The method of claim 9, further comprising transmitting, to the network entity, an acknowledgment of receiving the indication.

15. The method of claim 8, further comprising transmitting an indication, to the network entity, to retrain the ML model or switch to the different ML model.

16. The method of claim 15, wherein the indication comprises a deactivation of the ML model.

17. The method of claim 15, further comprising, before transmitting the indication to the network entity, receiving the indication from the entity associated with the UE to retrain the current ML model or switch to the different ML model.

18. The method of claim 15, wherein, if the indication is to retrain the ML model, the indication also includes information for the retraining.

19. The method of claim 15, wherein, if the indication is to switch to the different ML model, the indication also includes an identification of the different ML model.

20. A method of wireless communications by a user equipment (UE), comprising:
generating a performance report for a machine learning (ML) model running on at least one of the UE or a network entity; and
participating in a change to the ML model based on the performance report.

21. The method of claim 20, further comprising forwarding the performance report to a network entity.

22. The method of claim 20, further comprising receiving, from the network entity, assistance information to assist in generating the performance report.

23. The method of claim 22, wherein the assistance information comprises at least one of: ground truth information collected by the UE, an ID of the ML model, a corresponding channel station information (CSI) report configuration, and information regarding the CSI report configuration triggering occasion or reporting occasion.

24. The method of claim 22, wherein the assistance information is received periodically, or semi-persistently, or in response to a request transmitted to the network entity, by the UE or UE vendor.

25. The method of claim 20, wherein the performance report indicates at least one of: an indication of a difference in predicted and actual performance, general system performance, statistics per individual inference by the ML model, or statistics per multiple inferences by the ML model.

26. The method of claim 20, wherein the performance report indicates a likelihood fit into different ML models.

27. The method of claim 20, wherein participating in a change to the ML model based on the performance report comprises participating in retraining the ML model or switching to a different ML model.

28. The method of claim 27, further comprising transmitting an indication, to the network entity, to retrain the ML model or switch to the different ML model.

29. The method of claim 28, further comprising, before transmitting the indication to the network entity, receiving the indication from the entity associated with the UE, to retrain the ML model or switch to the different ML model.

30. The method of claim 28, wherein, if the indication is to retrain the ML model, the indication also includes information for the retraining.

31. The method of claim 28, wherein, if the indication is to switch to the different ML model, the indication also includes an identification of the different ML model.

32. The method of claim 31, wherein the indication comprises a deactivation of the ML model.

33. The method of claim 27, further comprising receiving an indication, from the network entity, to retrain the ML model or switch to the different ML model.

34. The method of claim 33, wherein the indication comprises a deactivation of the ML model.

35. A method of wireless communications by a network entity, comprising:
transmitting a performance report for a machine learning (ML) model running on at least one of a user equipment (UE) or the network entity; and
participating in a change to the ML model based on the performance report.

36. The method of claim 35, further comprising:
receiving assistance information generated by the UE; and
using the assistance information when generating the performance report.

37. The method of claim 36, wherein the assistance information comprises at least one of: ground truth information collected by the UE, an ID of the ML model, a corresponding channel station information (CSI) report configuration, and information regarding the CSI report configuration triggering occasion or reporting occasion.

38. The method of claim 36, wherein receiving the assistance information comprises receiving a baseline CSI report using a non-ML based precoder matrix indicator (PMI) codebook, wherein the baseline CSI report is based on same CSI reference signal (CSI-RS_resource for channel measurement as a ML-based CSI report.

39. The method of claim 38, further comprising transmitting a request or configuration of a baseline CSI report using non-ML based PMI codebook, wherein the configuration or request comprises configuring same CSI-RS resource for channel measurement for the ML-based CSI report and the baseline CSI report.

40. The method of claim 37, wherein the assistance information is received in response to a request from the network entity, or periodically, or semi-persistently.

41. The method of claim 35, wherein the performance report indicates at least one of: an indication of a difference in predicted and actual performance, general system performance, statistics per individual inference by the ML model, or statistics per multiple inferences by the ML model.

42. The method of claim 35, wherein the performance report indicates a likelihood fit into different ML models.

43. The method of claim 35, wherein participating in a change to the ML model based on the performance report comprises transmitting an indication, for the UE to retrain the ML model or switch to the different ML model.

44. The method of claim 43, wherein the indication comprises a deactivation of the ML model.

45. The method of claim 43, wherein, if the indication is to retrain the ML model, the indication also includes information for the retraining.

46. The method of claim 43, wherein, if the indication is to switch to the different ML model, the indication also includes an identification of the different ML model.

47. The method of claim 43, further comprising receiving an acknowledgment of the UE receiving the indication.

48. The method of claim 37, further comprising receiving an indication, from the UE, to retrain the ML model or switch to the different ML model.

49. The method of claim 48, wherein the indication comprises a deactivation of the ML model.

50. A method of wireless communications by a network entity, comprising:
receiving a performance report for a machine learning (ML) model running on at least one of the a user equipment (UE) or the network entity; and
participating in a change to the ML model based on the performance report.

51. The method of claim 50, further comprising transmitting assistance information to assist the UE in generating the performance report.

52. The method of claim 51, wherein the assistance information comprises at least one of: ground truth information collected by the UE, an ID of the ML model, a corresponding channel station information (CSI) report configuration, and information regarding the CSI report configuration triggering occasion or reporting occasion.

53. The method of claim 51, wherein the assistance information is received periodically, or semi-persistently, or in response to a request transmitted to the network entity, by the UE or UE vendor.

54. The method of claim 50, wherein the performance report indicates at least one of: an indication of a difference in predicted and actual performance, general system performance, statistics per individual inference by the ML model, or statistics per multiple inferences by the ML model.

55. The method of claim 54, wherein the performance report indicates a likelihood fit into different ML models.

56. The method of claim 54, wherein participating in a change to the ML model based on the performance report comprises participating in retraining the ML model or switching to a different ML model.

57. The method of claim 56, further comprising transmitting an indication, to the network entity, to retrain the ML model or switch to the different ML model.

58. The method of claim 57, wherein, if the indication is to retrain the ML model, the indication also includes information for the retraining.

59. The method of claim 57, wherein, if the indication is to switch to the different ML model, the indication also includes an identification of the different ML model.

60. The method of claim 59, wherein the indication comprises a deactivation of the ML model.

61. The method of claim 50, further comprising transmitting an indication for the UE to retrain the ML model or switch to the different ML model.

62. The method of claim 61, wherein the indication comprises a deactivation of the ML model.

63. An apparatus, comprising: a memory comprising executable instructions; and a processor configured to execute the executable instructions and cause the apparatus to perform a method in accordance with any one of claims 1-60.

64. An apparatus, comprising means for performing a method in accordance with any one of claims 1-60.

65. A non-transitory computer-readable medium comprising executable instructions that, when executed by a processor of an apparatus, cause the apparatus to perform a method in accordance with any one of claims 1-60.

66. A computer program product embodied on a computer-readable storage medium comprising code for performing a method in accordance with any one of claims 1-60.
